(19) United States
(12) Patent Application Publication
(10) Pub. No.: US 2024/0249192 A1
(43) Pub. Date: Jul. 25, 2024

(54) Multi-Layer Perceptron Architecture For Times Series Forecasting

(71) Applicant: Google LLC, Mountain View, CA (US)

(72) Inventors: Sercan Omer Arik, San Francisco, CA (US); Si-An Chen, Taipei City (TW); Nathanael Christian Yoder, San Francisco, CA (US); Chun-Liang Li, Santa Clara, CA (US)

(21) Appl. No.: 18/417,556

(22) Filed: Jan. 19, 2024

Related U.S. Application Data
(60) Provisional application No. 63/441,068, filed on Jan. 25, 2023.

(51) Int. Cl. G06N 20/00

(52) U.S. Cl. CPC G06N 20/00

(57) ABSTRACT

The present disclosure provides an architecture for time series forecasting. The architecture is based on multi-layer perceptrons (MLPs), which involve stacking linear models with non-linearities between them. In this architecture, the time-domain MLPs and feature-domain MLPs are used to perform both time-domain and feature-domain operations in a sequential manner, alternating between them. In some examples, auxiliary data is used as input, in addition to historical data. The auxiliary data can include known future data points, as well as static information that does not vary with time. The alternation of time-domain and feature-domain operations using linear models allows the architecture to learn temporal patterns while leveraging cross-variate information to generate more accurate time series forecasts.

### CROSS-REFERENCE TO RELATED APPLICATIONS

The application claims the benefit under 35 U.S.C. § 119(e) of the filing date of U.S. patent application Ser. No. 63/441,068, for Multi-Layer Perceptrons Architecture for Time Series Forecasting, which was filed on Jan. 25, 2023, and which is incorporated here by reference.

### BACKGROUND

Time series forecasting is a field focused on predicting future values of a variable (also called a feature or a variate) or multiple related variables, given a set of historical observations. Time series forecasting is a prevalent problem in many real-world use cases, such as for forecasting demand for products, pandemic spread, and inflation rates. Approaches such as recurrent neural networks and transformer-based models have been employed as the basis for time series forecasting models. Traditional time series forecasting models, like ARIMA, are designed for univariate time-series modeling. Because of this, these types of models have limitations in dealing with the complexity of real-world data, which often have multiple interdependent covariates and additional information like static features and future time-varying features.

Recent advancements in deep learning have led to notable improvements in time series forecasting. Recurrent neural network and transformer-based time series forecasting models can model complex temporal dependencies and patterns from multivariate time-series data. In multivariate time series forecasting, it is commonly believed that multivariate models, such as those based on transformers or recurrent networks, should be more effective than univariate models, due to their ability to leverage cross-variate information. It has been shown that these types of models are significantly worse than univariate linear models, on most academic long-term forecasting benchmarks. The multivariate models seem to suffer from a higher risk of overfitting, especially when the target time series is not correlated to other covariates.

### BRIEF SUMMARY

The present disclosure describes an architecture for time series forecasting. The architecture is based on multi-layer perceptrons (MLPs). In this architecture, which when implemented is referred to as a time series mixer system, MLPs are used to perform both time-domain and feature-domain operations in a sequential manner, alternating between the two types of operations. The time series mixer system captures time-dependent features, e.g., features that vary with time within an input time series, through different trained weights in time-domain MLPs, corresponding to each time step. Because the system uses linear models, like MLPs, the weights are time-dependent. Further, the time series mixer system can be configured to learn relationships between features of the time-series data, which can vary from statistical correlations to more complex functions that are only identified through machine learning. The system retains the capacity of linear models to capture temporal patterns efficiently, while using cross-variate information typically used in recurrent-and transformer-based approaches, for improved time series forecasting.

Further, aspects of the disclosure can be extended to incorporate auxiliary data, such as future time-varying data and/or static information that does not vary with time. In these examples, the system can take advantage of heterogeneous inputs that are often accompanied with historical time-series data, but that are not utilized in univariate-based models.

The time series mixer includes MLPs that alternate between time-domain input and feature-domain input. Time-domain MLPs receive input data per time step, while feature-domain MLPs receive input data per feature, across multiple time steps. Input and intermediate data in the form of matrices, tensors, or tables, are transposed during processing by a time series mixer system to the correct input domain before further processing through an MLP or component of the system that depends on input being of the correct domain. Time-domain MLPs are reused or shared across all the features of an input time series, while feature-domain MLPs are reused or shared across all time steps of the input time series.

In addition, aspects of the disclosure provide for a normalization approach between both features and time steps alike. Applying two-dimensional normalization maintains scale across features and time steps, which leads to more accurate results given that features and time step are processed in an alternating manner, as described herein.

Aspects of the disclosure provide for at least the following technical advantages. Multivariate time series forecasting is available at a reduced performance cost relative to other approaches. The time series mixer system described herein retains the capacity of linear models to capture temporal patterns, while still being able to exploit cross-variate information typically associated with more complex and computationally intensive approaches, including recurrent neural networks and transformer-based architectures. The time series mixer system can be trained and implemented in fewer processing clock cycles and using less memory, while still providing time series forecasting results on par or better than recurrent-or transformer-based models. This is at least because the system on average has much fewer trainable parameters than recurrent-or transformer-based approaches. The relatively smaller model size and parameter quantity also make the systems described more efficient to scale for large-scale applications.

The interleaving design between time-mixing and feature-mixing operations efficiently utilizes both temporal dependencies and cross-variate information while limiting computational complexity and model size. At the same time, the system is less likely to suffer from overfitting than many other multivariate models. The proposed system can be implemented across a variety of different devices and is more conducive to model refinement and explainability analysis over more complex (and opaque) models used in multivariate time series forecasting.

### BRIEF DESCRIPTION OF THE DRAWINGS

FIG. 1 is a block diagram of an example time series mixer system, according to aspects of the disclosure.

FIG. 2 is a block diagram of the example mixer layer, according to aspects of the disclosure.

FIG. 3 is a block diagram of an example time mixing layer and an example feature mixing layer, according to aspects of the disclosure.

FIG. 4A is a flow diagram of an example process for time series forecasting, according to aspects of the disclosure.

FIG. 4B is a flow diagram of an example process for generating one or more output points using a plurality of MLPs, according to aspects of the disclosure.

FIG. 5 is a block diagram of an example time series mixer system with auxiliary data, according to aspects of the disclosure.

FIG. 6A is a flow diagram of an example process for time series forecasting with auxiliary data, according to aspects of the disclosure.

FIG. 6B is a flow diagram of an example process for generating one or more output points using a plurality of MLPs and auxiliary data, according to aspects of the disclosure.

FIG. 7 is a block diagram of an example computing environment for executing the time series forecasting using the described architecture.

FIG. 8 depicts a block diagram illustrating one or more models, such as for deployment in a data center housing a hardware accelerator on which the deployed models will execute for time series forecasting.

### DETAILED DESCRIPTION

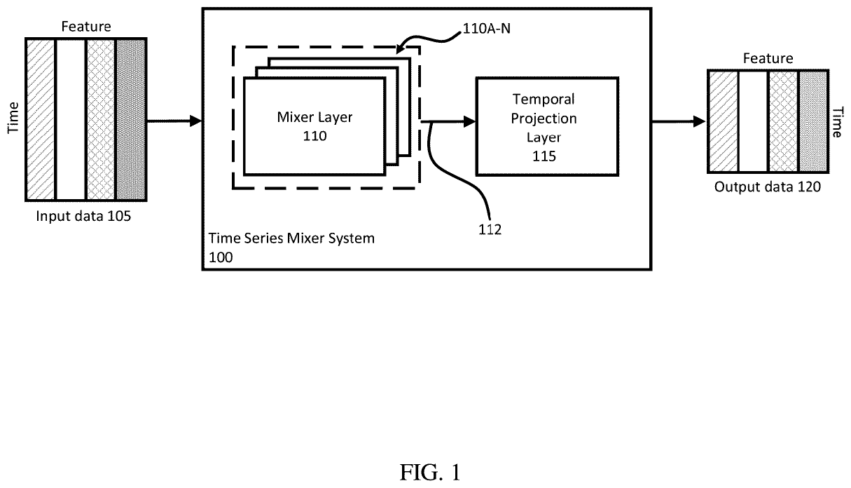

FIG. 1 is a block diagram of an example time series mixer system 100, according to aspects of the disclosure. The system can receive input data 105, which can be represented according to any of a variety of data structures, including vectors, tables, matrices, tensors, and so on. The input data 105 can include multiple data points, each point corresponding to a point in time or time step. Each point at a given time step can include values for one or more features or variables corresponding to the given time step. For example, the input data 105 can track historical observations of a weather system in a geographic region, hour by hour. At each hour, a data point in the input data 105 can include values for multiple features, such as atmospheric pressure, wind speed, or temperature.

As shown in the figures, the input data 105, the output data 120 and other examples of data are represented as a table of columns, along two dimensions (also referred to as domains). Data can vary along the time domain, meaning that a feature will have different values depending on the current time step. A time step is a predetermined measure of time. Depending on the use case or implementation of the system 100, a time step can represent a second, a minute, an hour, and so on.

Data can also vary along the feature domain, meaning that a time step will be associated with different values depending on the current feature. Although data is shown as two-dimensional in the figures, the feature domain can include multiple additional dimensions, each corresponding to a respective feature. The feature values of a data point can be represented as a vector or other data structure, which itself may be part of a more complex data structure, such as a multi-dimensional tensor.

The input data 105 is provided as input to the system 100, which generates output data 120. Output data 120 can also include multiple data points, representing values for features of the input data 105 at future time steps. The output data 120 can be projected to a length of time different from the input data 105. For example, input data 105 can represent weeks of historical data, while the output data 120 can represent predicted data for the next few hours or days. The time windows or scales between input and output data can vary from example-to-example. Output data 120 can represent multiple different predicted time series, in some examples in which the system 100 is configured to output more than one prediction. The multiple different predicted time series may also be of varying lengths, e.g., shorter to longer windows of forecasted values.

The system 100 includes a mixer layer 110 and a temporal projection layer 115. The system 100 is also shown with mixer layers 110A-N, although the number of mixer layers implemented can vary from example-to-example. When reference is made to a single component of the system 100, such as the mixer layer 110, it is understood that multiple of that component can be implemented, in various examples.

The system receives the input data 105 at the mixer layer 110, and generates intermediate data, represented by line 112 between the mixer layer 110 and the temporal projection layer 115. The intermediate data is provided as input to the temporal projection layer 115. The system 100 at the temporal projection layer 115 processes the intermediate data as described herein, but also projects the data to the appropriate scale for the output data 120. In this specification, any data not received as input data or generated as output data to the system or component, or layer of the system may be referred to as intermediate data. The temporal projection layer 115 can include a fully-connected layer, and the system 100 can transpose data input to the temporal projection layer 115 along the time domain before processing the data. After generating the projected data, the system 100 can transpose the data again, this time along the feature domain. As an example, the system 100 can transpose a matrix M of input data by performing the matrix transpose operation (M^{T}).

The systems described herein can be implemented as part of a system for forecasting future events or values. For example, aspects of the disclosure can be implemented for predicting future electrical demand on a power grid, future traffic patterns in a traffic system, or future economic events in a financial system. Input data and auxiliary data described herein can relate to larger systems like power grids, traffic systems, and financial systems, encoding information about these larger systems over a time period or window.

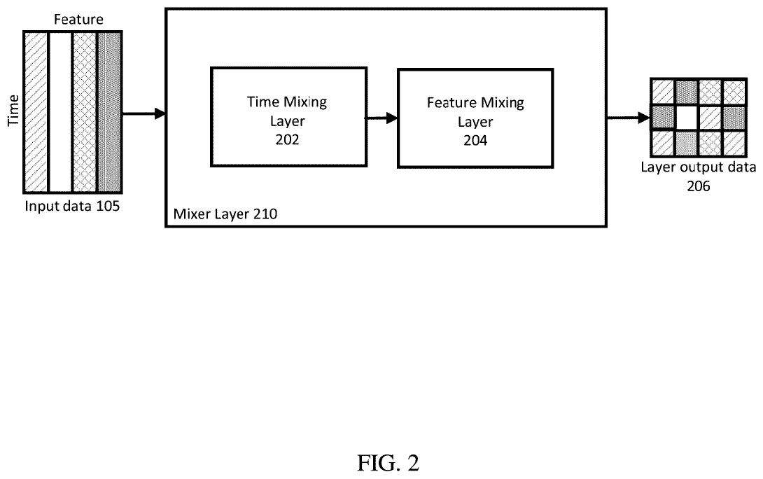

FIG. 2 is a block diagram of an example mixer layer 210, according to aspects of the disclosure. The mixer layer 110 may be implemented as shown and described with reference to FIG. 2 and the mixer layer 210. As before, the mixer layer 210 receives the input data 105. The mixer layer 210 includes a time mixing layer 202 and a feature mixing layer 204.

In this specification, a “mixing layer” or “mixer layer” can refer to a layer of both time-domain and feature-domain operations. Additionally, a “time mixing layer” or “time mixer layer” can refer to a layer of time-domain operations, while a “feature mixing” or “feature mixer” layer can refer to a layer of feature-domain operations. Layers are collections of operations that at least partially depend on trainable weights or parameter values. Machine learning models may include different layers, such as fully-connected layers, dropout layers, etc.

At the time mixing layer 202, the system 100 performs one or more time-domain operations on the input data 105. A time-domain operation can refer to one or more actions or calculations on data along the time domain. In other words, the system 100 performs time-domain operations and assumes that data input as part of the operations vary with different time steps. An example architecture of the time mixing layer 202 and the feature mixing layer 204 is described herein. The system 100 passes output from the time mixing layer 202 to the feature mixing layer 204. At the feature mixing layer 204, the system 100 performs feature-domain operations and assumes that data input as part of performing the operations varies with the various features represented in the input data 105.

The alternating of time-mixing and feature-mixing operations allows for the use of both temporal dependencies and cross-variate information, while limiting computational complexity and model size. The system 100 can use a longer lookback window than multivariate approaches relying on recurrent networks or transformers. Put another way, aspects of the disclosure provide for parameter growth as the sum of the length of a lookback window L and number of features C (e.g., O(L+C)), instead of the product of the length of the lookback window and number of features (e.g., O(LC)), as in other approaches.

The output of the mixer layer 210 is layer output data 206. Layer output data 206 can be fed to a subsequent mixing layer, e.g., one of mixing layers 110A-N. If the mixer layer 210 is the last mixing layer in a sequence of layers for the system 100, then the layer output data 206 is intermediate data that is passed as input to the temporal projection layer 115. The number of mixer layers 110A-N can vary from implementation-to-implementation, based on, for example, computational resource availability or trade-offs between accuracy and time spent to generate forecasted time series.

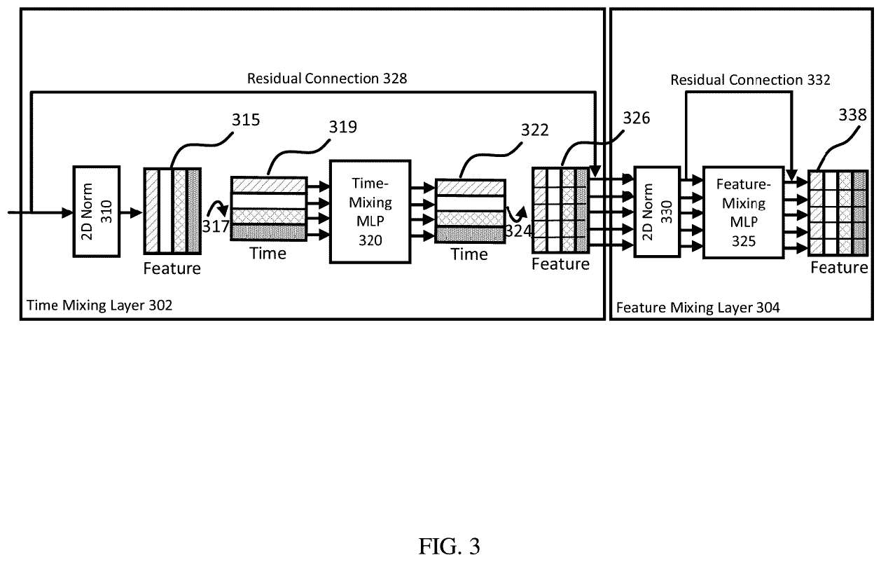

FIG. 3 is a block diagram of an example time mixing layer 302 and an example feature mixing layer 304, according to aspects of the disclosure. Time mixing layer 202 and feature mixing layer 204 may be implemented as shown and described with reference to time mixing layer 302 and feature mixing layer 304, respectively.

The system 100 receives input to the time mixing layer 302 and normalizes the input at a two-dimensional normalization layer (2D Norm) layer 310. At the 2D Norm layer 310, the system 100 normalizes over both time and feature dimensions of the input, to maintain a consistent scale between the time-mixing and feature-mixing operations at the later stages of the time mixing layer 302 and feature mixing layer 304, respectively. This form of normalization contrasts with other approaches that normalize along only the time or feature domain because operations in those approaches do not mix the operations as described herein.

The system 100 transposes normalized data 315, shown by curved arrow 317. The system 100 is configured to transpose data if needed, which is determined by the input assumption of the operations downstream to the transposition operation. For example, time-mixing MLP 320 includes operations performed along the time-domain, e.g., time step by time step. The domain of a set of data, e.g., the domain of normalized data 315, transposed data 319, etc., is denoted in the figures with either a label of ‘Time’ or a label of ‘Feature,’ where appropriate.

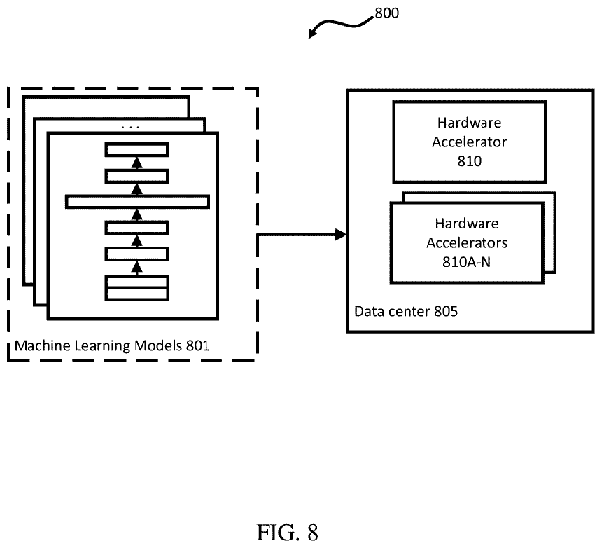

The time-mixing MLP 320 is a multi-layer perceptron trained to model temporal patterns in time series data. Temporal patterns can include trends and seasonal patterns, e.g., long-term inflation, day-of-week effects, etc. In one example, the time-mixing MLP 320 includes a fully-connected layer, followed by an activation function and a dropout layer. The activation function can be ReLU, although other activation functions can be used, such as leaky ReLU, GELU, Swish, etc. The time-mixing MLP 320 includes a dropout layer. It has been shown that a single-layer linear model can already learn complex temporal patterns, however, in some examples, the number of fully-connected layers, dropout layers, and type of activation function used to implement the time-mixing MLP 320 can vary. The time-mixing MLP 320 and other trainable components of the systems described herein may be trained, for example according to the description in reference to FIG. 8, below.

The time-mixing MLP 320 is shared across each feature of the transposed data 319. In other words, the system 100 processes values for each feature of the transposed data 319 through the time-mixing MLP 320. Processing data through the time-mixing MLP 320 is an example of the system performing one or more time-domain operations. For example, time-domain operations can include processing the transposed data 319 through the fully-connected layer of the time-mixing MLP 320, performing the activation function corresponding to the time-mixing MLP 320, and/or performing operations corresponding to the dropout layer of the time-mixing MLP 320.

The system 100 generates time-mixing MLP output 322 after performing the time-domain operations corresponding to the time-mixing MLP 320. The system 100 transposes the time-mixing MLP output 322, denoted by curved arrow 324. Transposed data 326 is in the feature domain, instead of the time domain.

At the feature mixing layer 304, the system 100 receives the transposed data 326, as well as residual data along a residual connection 328. Residual connections in both the time mixing layer 302 and the feature mixing layer 304 can be used in the system 100 to learn architectures with multiple mixing layers more efficiently and allow the system to ignore some time-mixing and feature-mixing operations where appropriate. How the system 100 uses the residual connections depends on how the system 100 is trained, described herein with reference to FIG. 8. The residual data for the residual connection 328 is input to the time mixing layer 302, before the system passes the input through the 2D Norm layer 310.

The system 100 receives the transposed data 326 at a 2D Norm layer 330, which can be implemented substantially the same as the 2D Norm layer 310. The system 100 passes normalized data (not shown) as input to the feature-mixing MLP 325.

The feature-mixing MLP 325 is a multi-layer perceptron trained to model cross-variate information in time series data. Cross-variate information can include correlations between different variables, e.g., an increase in blood pressure associated with a rise in body weight. In one example, the feature-mixing MLP 325 can be a sequence of operations as follows: a fully-connected layer, an activation function (e.g., ReLU), a dropout layer, a fully-connected layer, and a dropout layer. In some examples, the number of fully-connected layers, dropout layers, and type of activation function used to implement the feature-mixing MLP 325 can vary.

The system 100 generates layer output data 338, using output from the feature-mixing MLP 325 and the residual data from the residual connection 332. The residual data from the residual connection 332 is data normalized from the 2D Norm layer 330. The system 100 can pass the layer output data 338 to a downstream mixer layer (not shown), or to a temporal projection layer, e.g., the temporal projection layer 115. By applying normalization on the input—instead of the output—of the layer, the residual connection maintains the same scale as the input to the layer.

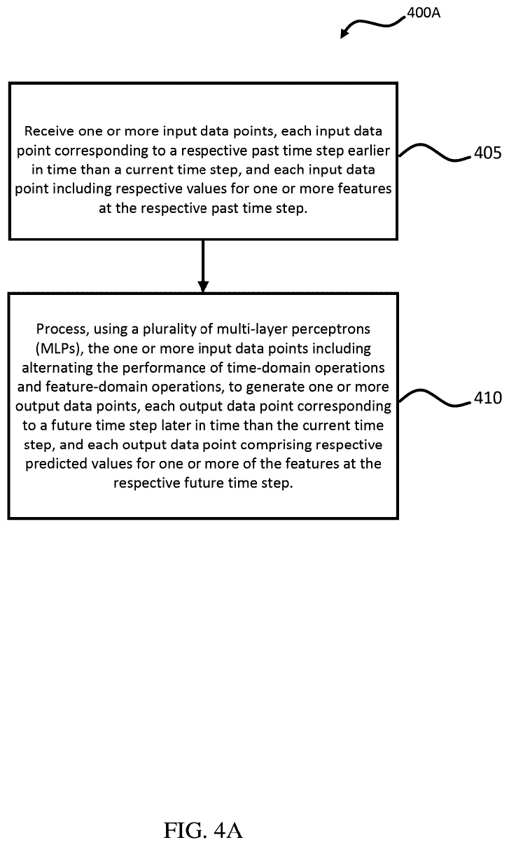

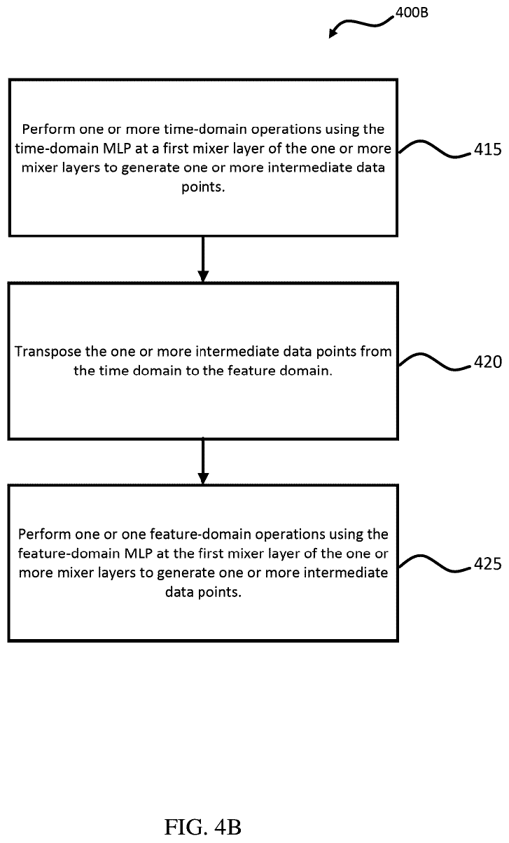

FIG. 4A is a flow diagram of an example process 400A for time series forecasting, according to aspects of the disclosure. An example time mixing system, for example the system 100, can perform the operations described with reference to the flow diagrams, including the example processes 400A, 400B of FIGS. 4A and 4B.

The system receives one or more input data points, according to block 405. Each input data point corresponds to a respective past time step earlier in time than a current time step. The current time step can vary depending on the input data and/or the time at which the system receives the input data. Time steps earlier and later in time than the current time step can be referenced relative to the current time step. For example, if current time step is t=0, then a time step earlier in time to the current time step can be referred to as t=−1, and a time step later in time to the current time step can be referred to as t=1. Each input data point also includes respective values for one or more features at a past time step.

The system processes, using a plurality of multi-layer perceptrons (MLPs), the one or more input data points including alternating the performance of time-domain operations and feature-domain operations, according to block 410. In processing the one or more input data points as described herein, the system generates one or more output data points. Each output data point corresponds to a respective future time step later in time than the current time step, and each output data point including respective predicted values for one or more of the features at the respective future time step.

The plurality of MLPs includes one or more time-domain MLPs and one or more feature-domain MLPs. The time-domain MLPs are trained to perform time-domain operations on input data, while the feature-domain MLPs are trained to perform feature-domain operations.

FIG. 4B is a flow diagram of an example process 400B for generating one or more output points using a plurality of MLPs, according to aspects of the disclosure. The system can perform the process 400B using one or more mixer layers. Each mixer layer includes a time-domain MLP and a feature-domain MLP.

The system performs one or more time-domain operations using the time-domain MLP at a first mixer layer of the one or more mixer layers to generate one or more intermediate data points, according to block 415.

The system transposes the one or more intermediate data points from the time domain to the feature domain, according to block 420.

The system performs the one or more feature-domain operations on the one or more transposed intermediate data points, using a feature-domain MLP of the first mixer layer, according to block 425.

The system can pass layer output data from the mixer layer to a downstream mixer layer or pass the data to a temporal projection layer. At the temporal projection layer, the system projects the time window or range of the layer output data to a predetermined window or range for the output data.

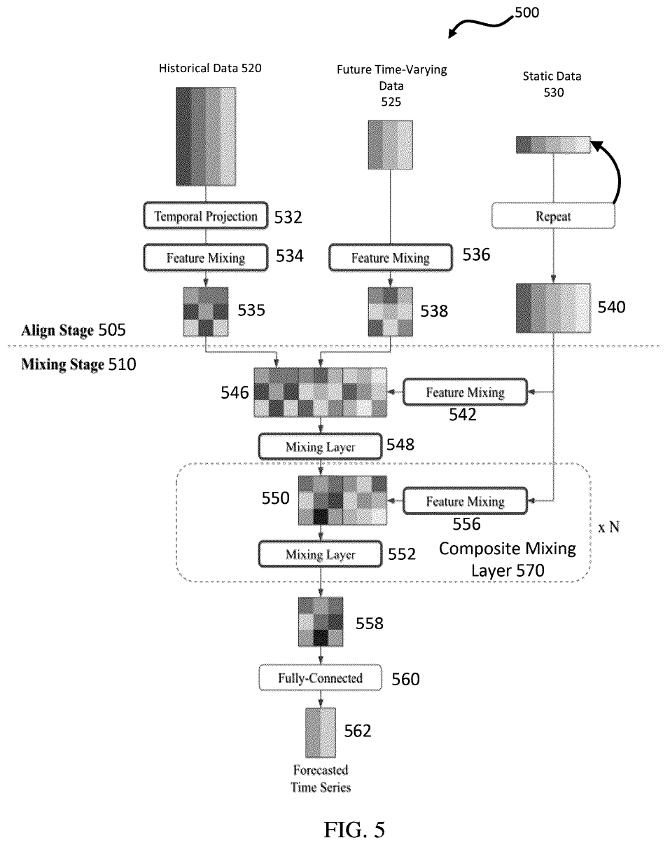

FIG. 5 is a block diagram of an example time series mixer system 500 with auxiliary data, according to aspects of the disclosure. In addition to historical observations, many real-world scenarios allow the use of static and future time-varying features, referred to collectively as auxiliary data or information. Static features can be location information or generally any information that does not vary from time step to time step. Future time-varying features—also referred to as future features—are features that vary in time, but which are already known. For example, in a time series tracking salary information for a group of employees, a future time-varying feature can be the occurrence of a promotion for one or more employees in subsequent weeks.

Operations performed by the system 500 are divided into an align stage 505 and a mixing stage 510. In the align stage 505, the system 500 receives historical data 520, future time-varying future data 525, and static data 530. The operations performed on the historical data 520, future time-varying future data 525, and the static data 530, during the align stage 505 can collectively be referred to as alignment operations or aligning the input data.

The system 500 processes the historical data 520 through a temporal projection layer 532. The temporal projection layer 532 can be implemented as described with reference to the temporal projection layer 115 and be trained to learn temporal patterns from the input data, in addition to projecting an input time window length to a target forecast length. The system 500 processes output from the temporal projection layer 532 through a feature mixing layer 534. The feature mixing layer 534 can include feature-domain operations, which the system 500 performs on the now temporally-projected historical data. The result of the system 500 processing the historical data 520 through the temporal projection layer 532 and the feature mixing layer 534 is feature-mixed historical data 535.

Referring to the align stage 505, the system 500 receives future time-varying future data 525, and processes that data through a feature mixing layer 534. The feature mixing layer 534 can be implemented and trained in a manner like other feature mixing layers described herein, e.g., the feature mixing layer 534, or the feature mixing layer 204. Output from the feature mixing layer 536 is feature-mixed future time-varying future data 538.

Although separate feature mixing layers 534, 536, and 542 are shown and described with reference to FIG. 5, in some examples some or all the feature mixing layers may be shared among the historical data 520, future time-varying data 525, and static data 530. For example, the system 500 may process the static data 530 through one or both feature mixing layers 534 and 536.

The last part of the align stage 505 involves the static data 530. The system 500 repeats instances of the static data 530 to generate repeated static data 540, whose time dimension matches the projected length output by the temporal projection layer 532.

Turning to the mixing stage 510, the system 500 processes the repeated static data 540 through a feature mixing layer 542, which can be implemented and trained as with the other feature mixing layers described herein. The system 500 concatenates the feature-mixed historical data 535, with the feature-mixed future time-varying future data 538 and the output of the feature mixing layer 542, to generate concatenated data 546. The system 500 processes the concatenated data 546 through a mixing layer 548. The mixing layer 548 can be implemented and trained as described with reference to other mixing layers, e.g., mixer layer 210.

Following the mixing layer 548, the system 500 can implement multiple additional mixing layers, as shown in FIG. 5 with reference to layer input data 550, mixing layer 552, and feature mixing layer 556. The dotted box surrounding the layer input data 550, mixing layer 552, and feature mixing layer 556 represents a composite mixing layer 570. The “x N” indicates that there may be N composite layers arranged in a sequence. The system 500 can use output from earlier layers in the sequence as input to later layers in the sequence. The number N can vary from implementation-to-implementation, based on, for example, computational resource availability or trade-offs between accuracy and time spent to generate forecasted time series.

Turning to the composite mixing layer 570 of the N layers implemented in the system 500, the system 500 generates the layer input data 550 by concatenating the output from the mixing layer 548 with output from a feature mixing layer 556. The system 500 takes, as input to the feature mixing layer 556, repeated static data 540. The feature mixing layer 556 allows the system to learn cross-variate information during training, which can vary for each composite layer. The system 500 processes the layer input data 550 through mixing layer 552. Recall that mixing layer includes both time-domain and feature-domain operations. The architecture of the system 500 as described leverages temporal patterns and cross-variate information from all features, collectively, through the alternation of time-domain and feature-domain operations.

The system 500 passes output from the mixing layer 552 to the next composite layer in the sequence (not shown). After processing the data through each composite layer, the system generates mixed data 558. The system 500 processes the mixed data 558 through a fully-connected layer 560, to generate a forecasted time series 562. As examples, the forecasted time series 562 real values of the forecasted time series, optimized by mean absolute error or mean square error. In some examples, the forecasted time series 562 may include parameter values of a target distribution, such as a negative binomial distribution.

In some examples, historical data is processed only with future time-varying data or static data, but not both. In those examples, the system omits components of the system 500 associated with the omitted type of auxiliary data. For example, if future time-varying data is not received as input, then the system does not implement a feature mixing layer 536.

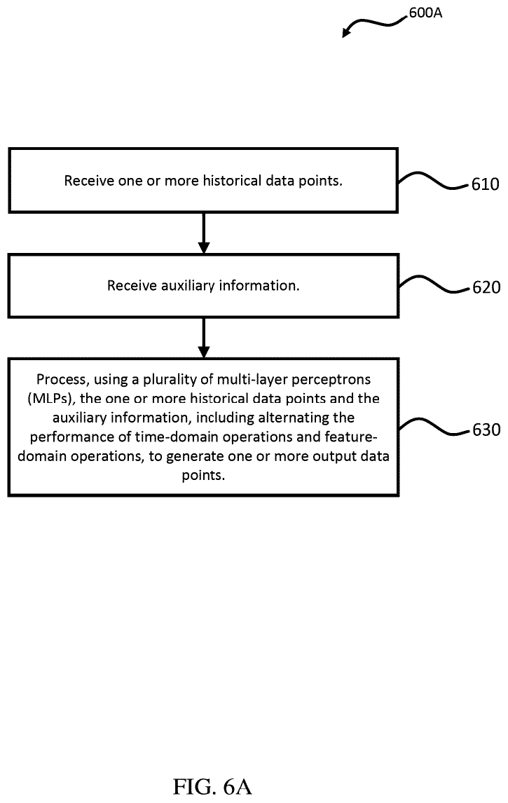

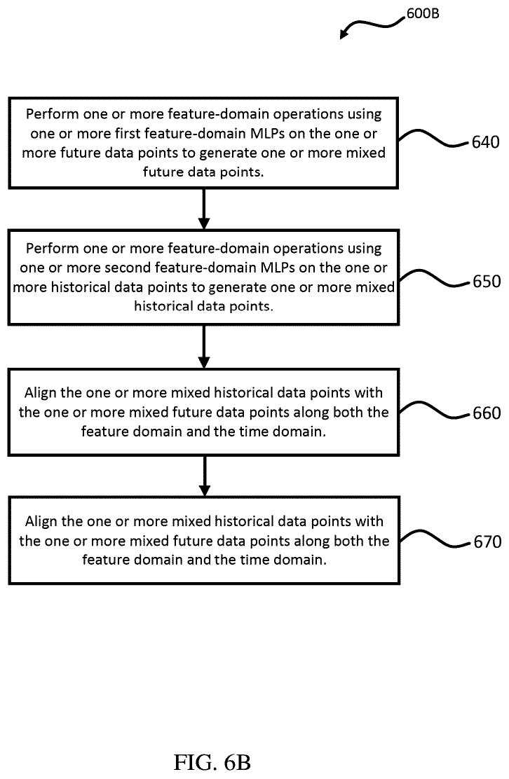

FIG. 6A is a flow diagram of an example process 600A for time series forecasting with auxiliary data, according to aspects of the disclosure. A system, for example system 500, appropriately configured, can perform the operations of process 600A.

The system receives one or more historical data points, according to block 610. Each historical data point can correspond to a respective past time step earlier in time than a current time step. Each historical data point can correspond to respective values for one or more features at the respective past time step.

The system receives auxiliary data, according to block 620. The auxiliary data can include one or more time-varying future data points, static data, or both the one or more time-varying future data points and the static data.

The system processes, using a plurality of multi-layer perceptrons (MLPs), the one or more historical data points and the auxiliary data, including alternating the performance of time-domain operations and feature-domain operations, according to block 630. As part of the processing, the system generates one or more output data points, each output data point corresponding to a respective future time step later in time than the current time step, and each output data point including respective predicted values for one or more of the features at the respective future time step. The one or more output data points can be part of a forecasted time series, e.g., as shown and described with reference to FIG. 5.

FIG. 6B is a flow diagram of an example process 600B for generating one or more output points using a plurality of MLPs and auxiliary data, according to aspects of the disclosure.

The system performs one or more feature-domain operations using one or more first feature-domain MLPs on the one or more future data points to generate one or more mixed future data points, according to block 640. For example, the first feature domain MLPs can be implemented as part of the feature mixing layer 536 of FIG. 5.

The system performs one or more feature-domain operations using one or more second feature-domain MLPs on the one or more historical data points to generate one or more mixed historical data points, according to block 650. For example, the second feature domain MLPs can be implemented as part of the feature mixing layer 534.

The system aligns the one or more mixed historical data points with the one or more mixed future data points along both the feature domain and the time domain, according to block 660. As part of aligning the data, the system processes the historical data through a temporal projection layer to project the data to the same temporal dimension as the output data. Aligning the data can also include aligning the historical and future value data with static data, which the system repeats a number of times until matching the shape of the historical and future value data.

The system processes, using a plurality of multi-layer perceptrons (MLPs), the aligned mixed future and mixed historical data points to generate the one or more output data points, according to block 670. For example, the system processes the aligned data as shown and described with reference to FIG. 5.

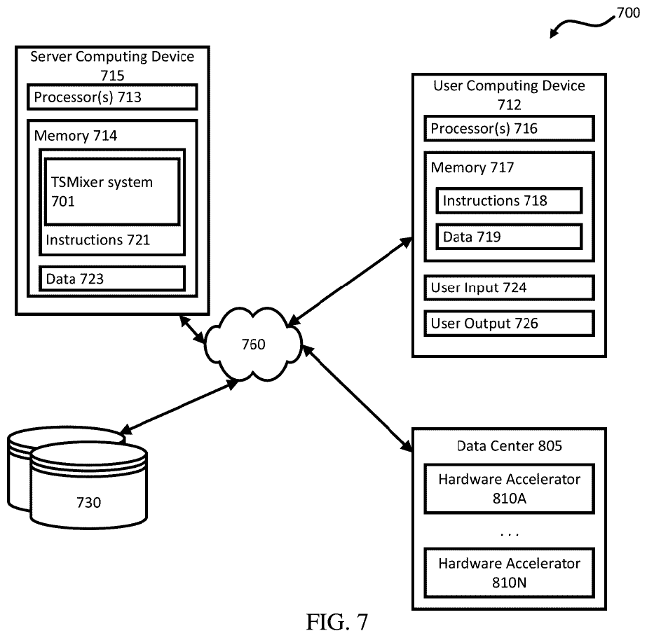

FIG. 7 is a block diagram of an example computing environment 700 for executing the time series forecasting using the described architecture. The architecture can be implemented on one or more devices having one or more processors in one or more locations, such as in server computing device 715. User computing device 712 and the server computing device 715 can be communicatively coupled to one or more storage devices 730 over a network 760. The storage device(s) 730 can be a combination of volatile and non-volatile memory and can be at the same or different physical locations than the computing devices 712, 715. For example, the storage device(s) 730 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 715 can include one or more processors 713 and memory 714. The memory 714 can store information accessible by the processor(s) 713, including instructions 721 that can be executed by the processor(s) 713. The memory 714 can also include data 723 that can be retrieved, manipulated, or stored by the processor(s) 713. The memory 714 can be a type of non-transitory computer readable medium capable of storing information accessible by the processor(s) 713, such as volatile and non-volatile memory. The processor(s) 713 can include one or more central processing units (CPUs), graphics processing units (GPUs), field-programmable gate arrays (FPGAs), and/or application-specific integrated circuits (ASICs), such as tensor processing units (TPUs).

The instructions 721 can include one or more instructions that when executed by the processor(s) 713, causes the one or more processors to perform actions defined by the instructions. The instructions 721 can be stored in object code format for direct processing by the processor(s) 713, or in other formats including interpretable scripts or collections of independent source code modules that are interpreted on demand or compiled in advance. The instructions 721 can include instructions for implementing processes consistent with aspects of this disclosure. Such processes can be executed using the processor(s) 713, and/or using other processors remotely located from the server computing device 715.

Time series mixer system 701 can be implemented using memory and one or more processors, such as on server computing device 715 and/or user computing device 712. Time series mixer system 701 can be implemented according to any time series mixer system described herein, such as system 100 or system 500.

The data 723 can be retrieved, stored, or modified by the processor(s) 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII, or Unicode. Moreover, the data 723 can include information sufficient to identify relevant information, such as numbers, descriptive text, proprietary codes, pointers, references to data stored in other memories, including other network locations, or information that is used by a function to calculate relevant data.

The user computing device 712 can also be configured like the server computing device 715, with one or more processors 716, memory 717, instructions 718, and data 719. The user computing device 712 can also include a user output 726, and a user input 724. The user input 724 can include any appropriate mechanism or technique for receiving input from a user, such as keyboard, mouse, mechanical actuators, soft actuators, touchscreens, microphones, and sensors.

The server computing device 715 can be configured to transmit data to the user computing device 712, and the user computing device 712 can be configured to display at least a portion of the received data on a display implemented as part of the user output 726. The user output 726 can also be used for displaying an interface between the user computing device 712 and the server computing device 715. The user output 726 can alternatively or additionally include one or more speakers, transducers or other audio outputs, a haptic interface or other tactile feedback that provides non-visual and non-audible information to the platform user of the user computing device 712.

Although FIG. 7 illustrates the processors 713, 716 and the memories 714, 717 as being within the computing devices 715, 712, components described in this specification, including the processors 713, 716 and the memories 714, 717 can include multiple processors and memories that can operate in different physical locations and not within the same computing device. For example, some of the instructions 721, 718 and the data 723, 719 can be stored on a removable SD card and others within a read-only computer chip. Some or all the instructions and data can be stored in a location physically remote from, yet still accessible by, the processors 713, 716. Similarly, the processors 713, 716 can include a collection of processors that can perform concurrent and/or sequential operation. The computing devices 715, 712 can each include one or more internal clocks providing timing information, which can be used for time measurement for operations and programs run by the computing devices 715, 712.

The server computing device 715 can be configured to receive requests to process data from the user computing device 712. For example, the environment 700 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 712 may receive and transmit data specifying target computing resources to be allocated for executing a machine learning model trained to perform a particular task, such as generating a time series forecast using the time series mixer system 701.

The devices 712, 715 can be capable of direct and indirect communication over the network 760. The devices 715, 712 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. The network 760 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 760, in addition or alternatively, can also support wired connections between the devices 712, 715, including over various types of Ethernet connection.

Although a single server computing device 715 and user computing device 712 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Environment 700 can also include data center 805 implementing hardware accelerators 810A-N, as described with reference to FIG. 8.

FIG. 8 depicts a block diagram 800 illustrating one or more models 801, such as for deployment in a data center 805 housing a hardware accelerator 810 on which the deployed models will execute for time series forecasting. The hardware accelerator can be any type of processor, such as a CPU, GPU, FPGA, or ASIC such as a TPU. The hardware accelerator 810 can be one of multiple accelerators, e.g., hardware accelerators 810A-N, or other types of processors, configured for processing a trained machine learning and/or configured for training a machine learning model.

An architecture of a model can refer to characteristics defining the model, such as characteristics of layers for the model, how the layers process input, or how the layers interact with one another. The architecture of the model can also define types of operations performed within each layer. For example, the architecture of a mixer layer includes time-mixing and feature-mixing operations. One or more model architectures can be generated that can output results associated with time-series forecasting, according to aspects of the disclosure.

The machine learning models 801 can refer to any or all the models or layers described herein, which may be trained according to a machine learning training technique. For example, MLPs, mixing layers, feature mixing layers, time mixing layers, fully-connected layers, and dropout layers described with reference to the figures herein, can all be trained according to any of a variety of machine learning training techniques, such as backpropagation with gradient descent with weight update. The hardware accelerator 810 can be used to train the machine learning models 801. In this regard, the models 801 may be trained together, as one end-to-end model, or separately.

Training data for the system can correspond to a time series forecasting task, such as forecasting future values for a financial system, weather system, or predicting the future condition of a patient based on previous data. The training data can include historical data, future time-varying future data, and/or static data. The data may be pre-processed and split into a training set, a validation set, and/or a testing set. An example training/validation/testing split can be an 80/10/10 split, although any other split may be possible. The training data can be data within a window of length, e.g., 35 or 512 time steps. Training data can be provided from another device, e.g., a user computing device or server computing device.

The training data can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. In one example, the models 801 are trained using the Adam optimizer to minimize an error, such as the mean square error, between predicted and labeled time series forecasts. The models 801 can be evaluated using, for example, the mean square error and the mean absolute error as evaluation metrics.

The training examples can be labeled with a desired output for the model when processing the labeled training examples. The label and the model output can be evaluated through a loss function to determine an error, which can be backpropagated through the model to update weights for the model. For example, time series data can be split at a selected time step, with time series data before the selected time step being the training data, and time series data after the selected time step being the labels for the expected predicted time series data after processing the training data.

The gradient of the error with respect to the different weights of the candidate model on candidate hardware can be calculated, for example using backpropagation with gradient descent and weight update. The model can be trained until stopping criteria are met, such as performing a predetermined number of iterations for training, a maximum period of wall-clock time spent training, a convergence of loss across multiple iterations of training within a predetermined threshold, or when a minimum accuracy threshold is met.

The time series mixer system can be configured to output one or more time series forecasts, generated as output data. As examples, the output data can be any kind of value or distribution. The time series forecasts can be of different lengths, e.g., extending to different points in the future. For example, the models 801 can be trained to output forecasts up to 28, 96, 192, 336, and/or 720 time steps into the future.

As an example, the time series mixer system can be configured to send the output data for display on a client or user display. As another example, the time series mixer system can be configured to provide the output data as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, layer, or model.

The time series mixer system can further be configured to forward the output data to one or more other devices configured for translating the output data into an executable program written in a computer programming language. The time series mixer system can also be configured to send the output data to a storage device for storage and later retrieval.

Implementations of the present technology include, but are not restricted to, the following:
(1) A system including one or more processors configured to: receive one or more input data points, each input data point corresponding to a respective past time step earlier in time than a current time step, and each input data point including respective values for one or more features at the respective past time step; and process, using a plurality of multi-layer perceptrons (MLPs), the one or more input data points including alternating the performance of time-domain operations and feature-domain operations to generate one or more output data points, each output data point corresponding to a respective future time step later in time than the current time step, and each output data point including respective predicted values for one or more of the features at the respective future time step.
(2) The system of (1), wherein the plurality of multi-layer perceptrons includes: one or more time-domain MLPs trained to perform one or more time-domain operations on one or more data points including values for one or more features at each of a plurality of time steps, and one or more feature-domain MLPs trained to perform one or more feature-domain operations on one or more data points including values for the one or more features at a time step common to each of the one or more data points.
(3) The system of (2), wherein to process the one or more input data points, the one or more processors are configured to: process the one or more input data points through one or more mixer layers, each mixer layer including a respective time-domain MLP of the one or more time-domain MLPs and a respective feature-domain MLP of the one or more feature-domain MLPs, wherein to process the one or more mixer layers, the one or more processors are configured to: perform one or more time-domain operations using a first time-domain MLP at a first mixer layer of the one or more mixer layers to generate one or more intermediate data points; transpose the one or more intermediate data points from the time domain to the feature domain; and perform the one or more feature-domain operations on the one or more transposed intermediate data points, using a first feature-domain MLP of the first mixer layer.
(4) The system of (3), wherein for each time step, the one or more processors are configured to process each feature of the time step through the first time-domain MLP, and wherein for each feature, the one or more processors are configured to process each time step including a value for the feature through the first feature-domain MLP.
(5) The system of any one of (2) or (3), wherein in processing the one or more mixer layers, the one or more processors are further configured to: normalize the values of one or more data points input to each mixer layer along both the time domain and the feature domain.
(6) The system of any one of (1)-(5), wherein the one or processors are further configured to: receive one or more future data points, each future data point including respective values for one or more of the features at a respective future time step that is later in time than the current time step; perform one or more feature-domain operations using one or more first feature-domain MLPs on the one or more future data points to generate one or more mixed future data points; perform one or more feature-domain operations using one or more second feature-domain MLPs on the one or more input data points to generate one or more mixed input data points; align the one or more mixed input data points with the one or more mixed future data points along both the feature domain and the time domain; and process, using the plurality of multi-layer perceptrons (MLPs), the aligned mixed future and mixed input data points to generate the one or more output data points.
(7) The system of (6), wherein one or more processors are further configured to: receive static data including values of features that do not depend on time; perform one or more feature- domain operations using one or more third feature-domain MLPs on the static data to generate mixed static data; align the mixed static data with the one or more mixed input data points and the one or more mixed future data points; and process, using the plurality of multi-layer perceptrons (MLPs), the aligned mixed future, the aligned mixed input data points, and the aligned mixed static data to generate the one or more output data points.
(8) The system of (7), wherein the plurality of multi-layer perceptrons includes: one or more time-domain MLPs trained to perform one or more time-domain operations on one or more data points including values for one or more features for each of a plurality of time steps, and one or more feature-domain MLPs trained to perform one or more feature-domain operations on one or more data points including values for the one or more features at a common time step.
(9) The system of (8), wherein to process the aligned mixed future data points, the aligned mixed input data points, and the aligned mixed static data to generate the one or more output data points, the one or more processors are configured to process the one or more input data points through one or more mixer layers, each mixer layer including a respective time- domain MLP and a respective feature-domain MLP, wherein in processing the one or more input data points through the one or more mixer layers, the one or more processors are configured to: perform one or more time-domain operations using a first time-domain MLP of a first mixer layer to generate one or more intermediate data points; transpose the one or more intermediate data points from the time domain to the feature domain; and perform the one or more feature-domain operations using a first feature-domain MLP of the first mixer layer on the one or more transposed intermediate data points.
(10) The system of (9), wherein for each time step, the one or more processors are configured to process each feature of the time step through the first time-domain MLP, and wherein for each feature, the one or more processors are configured to process each time step including a value for the feature through the first feature-domain MLP.
(11) The system of (9) or (10), wherein, for each mixer layer, the one or more processors are further configured to: perform one or more feature-domain operations on the static data to generate respective mixed static data; and align the respective mixed static data with one or more data points that are output from one or more feature-domain operations performed at an earlier mixer layer.
(12) is a method performed by one or more processors and one or more memory devices, wherein the memory devices store instructions that are operable, when executed by the one or more processors, to perform the operations of any or all of (1)-(12).
(13) is one or more non-transitory computer-readable storage media, storing instructions that when executed by one or more processors, causes the one or more processors to perform the operations of any one of (1)-(12).
(14) is a method, including: receiving, by one or more processors, one or more input data points, each input data point corresponding to a respective past time step earlier in time than a current time step, and each input data point including respective values for one or more features at the respective past time step; and processing, by the one or more processors and using a plurality of multi-layer perceptrons (MLPs), the one or more input data points, the processing including alternating the performance of time-domain operations and feature- domain operations to generate one or more output data points, each output data point corresponding to a respective future time step later in time than the current time step, and each output data point including respective predicted values for one or more of the features at the respective future time step.
(15) The method of (14), wherein the plurality of multi-layer perceptrons includes: one or more time-domain MLPs trained to perform one or more time-domain operations on one or more data points including values for one or more features at each of a plurality of time steps, and one or more feature-domain MLPs trained to perform one or more feature-domain operations on one or more data points including values for the one or more features at a time step common to each of the one or more data points.
(16) The method of (15), wherein to process the one or more input data points, the one or more processors are configured to: process the one or more input data points through one or more mixer layers, each mixer layer including a respective time-domain MLP of the one or more time-domain MLPs and a respective feature-domain MLP of the one or more feature- domain MLPs, wherein to process the one or more mixer layers, the one or more processors are configured to: perform one or more time-domain operations using a first time-domain MLP at a first mixer layer of the one or more mixer layers to generate one or more intermediate data points; transpose the one or more intermediate data points from the time domain to the feature domain; and perform the one or more feature-domain operations on the one or more transposed intermediate data points, using a first feature-domain MLP of the first mixer layer.
(17) The method of (15) or (16), wherein the method further includes: receiving, by the one or more processors, auxiliary data, the auxiliary data including one or more time-varying future data points, static data, or both the one or more time-varying future data points and static data; and wherein processing the one or more data points further includes processing, using the plurality of multi-layer perceptrons (MLPs), the one or more input data points and the auxiliary data, including alternating the performance of time-domain operations and feature-domain operations to generate the one or more output data points.
(18) A system including: one or more processors configured to: receive one or more historical data points, each historical data point corresponding to a respective past time step earlier in time than a current time step, and each historical data point including respective values for one or more features at the respective past time step; receive auxiliary data, the auxiliary data including one or more time-varying future data points, static data, or both the one or more time-varying future data points and the static data; and process, using a plurality of multi-layer perceptrons (MLPs), the one or more historical data points and the auxiliary data, including alternating the performance of time-domain operations and feature-domain operations, to generate one or more output data points, each output data point corresponding to a respective future time step later in time than the current time step, and each output data point including respective predicted values for one or more of the features at the respective future time step.
(19) The system of (18), wherein in processing the one or more historical data points and the auxiliary data, the one or more processors are further configured to: perform one or more feature-domain operations using one or more first feature-domain MLPs on the one or more future data points to generate one or more mixed future data points; perform one or more feature-domain operations using one or more second feature-domain MLPs on the one or more historical data points to generate one or more mixed historical data points; align the one or more mixed historical data points with the one or more mixed future data points along both the feature domain and the time domain; and process, using the plurality of multi-layer perceptrons (MLPs), the aligned mixed future and mixed historical data points to generate the one or more output data points.
(20) The system of (19), wherein in aligning the one or more mixed historical data points with the one or more mixed future data points, the one or more processors are further configured to align the one or more mixed historical data points and the one or more mixed future data points with static data that has been repeated one or more times to match at least one dimension of the one or more mixed historical data points and the one or more mixed future data points.
(21) The system of claim 20, wherein in processing the one or more historical data points and the auxiliary data, the one or more processors are configured to: process the one or more historical data points and the auxiliary data through layers of a machine learning model, wherein, for each layer, the one or processors are configured to: perform one or more feature- mixing operations on the static data, concatenate the feature-mixed static data with layer input including the one or more historical data points and the one or more time-varying future data points, alternate performance of one or more time-domain operations and feature-domain operations on the concatenated data to generate mixed intermediate data, and provide the mixed intermediate data as output to another layer of the machine learning model.
(22) The system of (18) to (21), wherein the plurality of multi-layer perceptrons includes: one or more time-domain MLPs trained to perform one or more time-domain operations on one or more data points including values for one or more features at each of a plurality of time steps, and one or more feature-domain MLPs trained to perform one or more feature-domain operations on one or more data points including values for the one or more features at a time step common to each of the one or more data points.
(23) A method performed by one or more processors and one or more memory devices, wherein the memory devices store instructions that are operable, when executed by the one or more processors, to perform the operations of any one of (18)-(22).
(24) One or more non-transitory computer-readable storage media, storing instructions that when executed by one or more processors, causes the one or more processors to perform the operations of any one of (18)-(22).

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems. One or more processors in one or more locations implementing an example architecture according to aspects of the disclosure can perform the operations shown in the drawings and recited in the claims. Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system, comprising:
one or more processors configured to:
receive one or more input data points, each input data point corresponding to a respective past time step earlier in time than a current time step, and each input data point comprising respective values for one or more features at the respective past time step; and
process, using a plurality of multi-layer perceptrons (MLPs), the one or more input data points comprising alternating the performance of time-domain operations and feature-domain operations to generate one or more output data points, each output data point corresponding to a respective future time step later in time than the current time step, and each output data point comprising respective predicted values for one or more of the features at the respective future time step.

2. The system of claim 1, wherein the plurality of multi-layer perceptrons comprises:
one or more time-domain MLPs trained to perform one or more time-domain operations on one or more data points comprising values for one or more features at each of a plurality of time steps, and
one or more feature-domain MLPs trained to perform one or more feature- domain operations on one or more data points comprising values for the one or more features at a time step common to each of the one or more data points.

3. The system of claim 2,
wherein to process the one or more input data points, the one or more processors are configured to:
process the one or more input data points through one or more mixer layers, each mixer layer comprising a respective time-domain MLP of the one or more time-domain MLPs and a respective feature-domain MLP of the one or more feature-domain MLPs, wherein to process the one or more mixer layers, the one or more processors are configured to:
perform one or more time-domain operations using a first time-domain MLP at a first mixer layer of the one or more mixer layers to generate one or more intermediate data points;
transpose the one or more intermediate data points from the time domain to the feature domain; and
perform the one or more feature-domain operations on the one or more transposed intermediate data points, using a first feature-domain MLP of the first mixer layer.

4. The system of claim 3, wherein for each time step, the one or more processors are configured to process each feature of the time step through the first time-domain MLP, and wherein for each feature, the one or more processors are configured to process each time step comprising a value for the feature through the first feature-domain MLP.

5. The system of claim 3, wherein in processing the one or more mixer layers, the one or more processors are further configured to:
normalize the values of one or more data points input to each mixer layer along both the time domain and the feature domain.

6. The system of claim 1, wherein the one or processors are further configured to:
receive one or more future data points, each future data point comprising respective values for one or more of the features at a respective future time step that is later in time than the current time step;
perform one or more feature-domain operations using one or more first feature-domain MLPs on the one or more future data points to generate one or more mixed future data points;
perform one or more feature-domain operations using one or more second feature-domain MLPs on the one or more input data points to generate one or more mixed input data points;
align the one or more mixed input data points with the one or more mixed future data points along both the feature domain and the time domain; and
process, using the plurality of multi-layer perceptrons (MLPs), the aligned mixed future and mixed input data points to generate the one or more output data points.

7. The system of claim 6, wherein one or more processors are further configured to:
receive static data comprising values of features that do not depend on time;
perform one or more feature-domain operations using one or more third feature-domain MLPs on the static data to generate mixed static data;
align the mixed static data with the one or more mixed input data points and the one or more mixed future data points; and
process, using the plurality of multi-layer perceptrons (MLPs), the aligned mixed future, the aligned mixed input data points, and the aligned mixed static data to generate the one or more output data points.

8. The system of claim 7, wherein the plurality of multi-layer perceptrons comprises:
one or more time-domain MLPs trained to perform one or more time-domain operations on one or more data points comprising values for one or more features for each of a plurality of time steps, and
one or more feature-domain MLPs trained to perform one or more feature-domain operations on one or more data points comprising values for the one or more features at a common time step.

9. The system of claim 7, wherein to process the aligned mixed future data points, the aligned mixed input data points, and the aligned mixed static data to generate the one or more output data points, the one or more processors are configured to process the one or more input data points through one or more mixer layers, each mixer layer comprising a respective time-domain MLP and a respective feature-domain MLP, wherein in processing the one or more input data points through the one or more mixer layers, the one or more processors are configured to:
perform one or more time-domain operations using a first time-domain MLP of a first mixer layer to generate one or more intermediate data points;
transpose the one or more intermediate data points from the time domain to the feature domain; and
perform the one or more feature-domain operations using a first feature-domain MLP of the first mixer layer on the one or more transposed intermediate data points.

10. The system of claim 9, wherein for each time step, the one or more processors are configured to process each feature of the time step through the first time-domain MLP, and wherein for each feature, the one or more processors are configured to process each time step comprising a value for the feature through the first feature-domain MLP.

11. The system of claim 9, wherein, for each mixer layer, the one or more processors are further configured to:
perform one or more feature-domain operations on the static data to generate respective mixed static data; and
align the respective mixed static data with one or more data points that are output from one or more feature-domain operations performed at an earlier mixer layer.

12. A method comprising:
receiving, by one or more processors, one or more input data points, each input data point corresponding to a respective past time step earlier in time than a current time step, and each input data point comprising respective values for one or more features at the respective past time step; and
processing, by the one or more processors and using a plurality of multi-layer perceptrons (MLPs), the one or more input data points, the processing comprising alternating the performance of time-domain operations and feature-domain operations to generate one or more output data points, each output data point corresponding to a respective future time step later in time than the current time step, and each output data point comprising respective predicted values for one or more of the features at the respective future time step.

13. The method of claim 12, wherein the plurality of multi-layer perceptrons comprises:
one or more time-domain MLPs trained to perform one or more time-domain operations on one or more data points comprising values for one or more features at each of a plurality of time steps, and
one or more feature-domain MLPs trained to perform one or more feature-domain operations on one or more data points comprising values for the one or more features at a time step common to each of the one or more data points.

14. The method of claim 13,
wherein to process the one or more input data points, the one or more processors are configured to:
process the one or more input data points through one or more mixer layers, each mixer layer comprising a respective time-domain MLP of the one or more time-domain MLPs and a respective feature-domain MLP of the one or more feature-domain MLPs, wherein to process the one or more mixer layers, the one or more processors are configured to:
perform one or more time-domain operations using a first time-domain MLP at a first mixer layer of the one or more mixer layers to generate one or more intermediate data points;
transpose the one or more intermediate data points from the time domain to the feature domain; and
perform the one or more feature-domain operations on the one or more transposed intermediate data points, using a first feature-domain MLP of the first mixer layer.

15. The method of claim 12, wherein the method further comprises:
receiving, by the one or more processors, auxiliary data, the auxiliary data comprising one or more time-varying future data points, static data, or both the one or more time-varying future data points and static data; and
wherein processing the one or more data points further comprises processing, using the plurality of multi-layer perceptrons (MLPs), the one or more input data points and the auxiliary data, comprising alternating the performance of time-domain operations and feature-domain operations to generate the one or more output data points.

16. A system comprising:
one or more processors configured to:
receive one or more historical data points, each historical data point corresponding to a respective past time step earlier in time than a current time step, and each historical data point comprising respective values for one or more features at the respective past time step;
receive auxiliary data, the auxiliary data comprising one or more time-varying future data points, static data, or both the one or more time-varying future data points and the static data; and
process, using a plurality of multi-layer perceptrons (MLPs), the one or more historical data points and the auxiliary data, comprising alternating the performance of time-domain operations and feature-domain operations, to generate one or more output data points, each output data point corresponding to a respective future time step later in time than the current time step, and each output data point comprising respective predicted values for one or more of the features at the respective future time step.

17. The system of claim 16, wherein in processing the one or more historical data points and the auxiliary data, the one or more processors are further configured to:
perform one or more feature-domain operations using one or more first feature-domain MLPs on the one or more future data points to generate one or more mixed future data points;
perform one or more feature-domain operations using one or more second feature-domain MLPs on the one or more historical data points to generate one or more mixed historical data points;
align the one or more mixed historical data points with the one or more mixed future data points along both the feature domain and the time domain; and
process, using the plurality of multi-layer perceptrons (MLPs), the aligned mixed future and mixed historical data points to generate the one or more output data points.

18. The system of claim 17, wherein in aligning the one or more mixed historical data points with the one or more mixed future data points, the one or more processors are further configured to align the one or more mixed historical data points and the one or more mixed future data points with static data that has been repeated one or more times to match at least one dimension of the one or more mixed historical data points and the one or more mixed future data points.

19. The system of claim 18, wherein in processing the one or more historical data points and the auxiliary data, the one or more processors are configured to:
process the one or more historical data points and the auxiliary data through layers of a machine learning model, wherein, for each layer, the one or processors are configured to:
perform one or more feature-mixing operations on the static data,
concatenate the feature-mixed static data with layer input comprising the one or more historical data points and the one or more time-varying future data points,
alternate performance of one or more time-domain operations and feature-domain operations on the concatenated data to generate mixed intermediate data, and
provide the mixed intermediate data as output to another layer of the machine learning model.

20. The system of claim 16, wherein the plurality of multi-layer perceptrons comprises:
one or more time-domain MLPs trained to perform one or more time-domain operations on one or more data points comprising values for one or more features at each of a plurality of time steps, and
one or more feature-domain MLPs trained to perform one or more feature- domain operations on one or more data points comprising values for the one or more features at a time step common to each of the one or more data points.
